(19) United States
(12) Patent Application Publication
(10) Pub. No.: US 2025/0141957 A1
(43) Pub. Date: May 1, 2025

(54) EQUIPMENT GEOLOCATION USING A POOL AUTOMATION CONTROLLER

(71) Applicant: Zodiac Pool Systems LLC, Carlsbad, CA (US)

(72) Inventors: Minas Minassian, Carlsbad, CA (US); Jeremy Young, Carlsbad, CA (US); Darin Eames, Carlsbad, CA (US)

(73) Assignee: Zodiac Pool Systems LLC, Carlsbad, CA (US)

(21) Appl. No.: 18/931,740

(22) Filed: Oct. 30, 2024

Related U.S. Application Data
(60) Provisional application No. 63/546,669, filed on Oct. 31, 2023.

(51) Int. Cl. H04L 67/1061; H04W 4/021; H04W 4/38

(52) U.S. Cl. CPC H04L 67/1061; H04W 4/021; H04W 4/38

(57) ABSTRACT

A pool system may include a plurality of devices of equipment distributed among an area and a pool automation controller that includes a shortrange wireless communication device configured to communicate with a first wireless communication device of a first device of equipment and a second wireless communication device of a second device of equipment. The pool automation controller may determine locations within the area of the first device and the second device with respect to the pool automation controller based at least in part on a first set of characteristics of a first wireless signal and a second set of characteristics of a second wireless signal.

### CROSS REFERENCE TO RELATED APPLICATION(S)

This application is related to a U.S. patent application, filed on Oct. 30, 2024, and entitled “Multimode Network Communication for Pool Automation System,” which is considered co-pending with this application, and also claims the benefit of U.S. Provisional Patent Application No. 63/546,669, filed on Oct. 31, 2023, and entitled “Dual-Mode Communication And Equipment Geolocation Using A Pool Automation Controller,” the contents of which are hereby incorporated by reference in their entireties.

### BACKGROUND

Pool and spa systems may include a variety of equipment, such as pumps, vacuum ports, skimmers, heaters, lights, filters, etc. Equipment may be controlled by a pool automation controller by various means, such as relays or digital signals. The pool automation controller may also connect to a router of a network at a location associated with the equipment.

### FIELD

The present disclosure relates generally to pool automation systems and more particularly, although not exclusively, to geolocation of pool or spa equipment using shortrange wireless communications.

### BRIEF SUMMARY

Various examples are described including systems, methods, and devices relating to geolocation of devices of pool or spa equipment and systems, devices, and techniques for multimode communication within a pool or spa system.

A system of one or more computers can be configured to perform particular operations or actions by virtue of having software, firmware, hardware, or a combination of them installed on the system that in operation causes or cause the system to perform the actions. One or more computer programs can be configured to perform particular operations or actions by virtue of including instructions that, when executed by data processing apparatus, cause the apparatus to perform the actions. One general aspect includes a pool or spa system configured for automated identification of pool or spa equipment. The pool or spa system also includes a plurality of devices of equipment distributed among an area, a first device of equipment of the plurality of devices of equipment including a first wireless communication device and a second device of equipment of the plurality of devices of equipment including a second wireless communication device. The pool or spa system also includes pool automation controller including: a shortrange wireless communication device configured to communicate with the first wireless communication device and the second wireless communication device; a memory configured to store computer-executable instructions; and one or more processors configured to access the memory and execute the computer-executable instructions to at least: receive, using the shortrange wireless communication device, a first wireless signal from the first wireless communication device, the first wireless signal including a first set of characteristics; receive, using the shortrange wireless communication device, a second wireless signal from the second wireless communication device, the second wireless signal including a second set of characteristics; and determine locations within the area of the first device and the second device with respect to the pool automation controller based at least in part on the first set of characteristics and the second set of characteristics. Other embodiments of this aspect include corresponding computer systems, apparatus, and computer programs recorded on one or more computer storage devices, each configured to perform the actions of the methods.

One general aspect includes a computer-implemented method for automated identification of pool or spa equipment of a pool or spa system. The computer-implemented method also includes detecting a first device of equipment of the pool or spa system based at least in part on a first wireless signal received from a first wireless communication device via a shortrange wireless communication device, the first wireless signal including a first set of characteristics. The computer-implemented method also includes detecting a second device of equipment of the pool or spa system based at least in part on a second wireless signal received from a second wireless communication device via the shortrange wireless communication device, the second wireless signal including a second set of characteristics. The computer-implemented method also includes determine locations of the first device of equipment and the second device of equipment with respect to a different component of the pool or spa system based at least in part on the first set of characteristics and the second set of characteristics. Other embodiments of this aspect include corresponding computer systems, apparatus, and computer programs recorded on one or more computer storage devices, each configured to perform the actions of the methods.

One general aspect includes a pool automation controller for a pool or spa system configured for automated identification of pool or spa equipment. The pool automation controller also includes a shortrange wireless communication device configured to communicate with a plurality of wireless communication devices. The pool automation controller also includes a memory configured to store computer-executable instructions. The pool automation controller also includes one or more processors configured to access the memory and execute the computer-executable instructions to at least: receive, using the shortrange wireless communication device, a first wireless signal from a first wireless communication device of a first device equipment, the first wireless signal including a first set of characteristics; receive, using the shortrange wireless communication device, a second wireless signal from a second wireless communication device of a second device of equipment, the second wireless signal including a second set of characteristics; and determine locations of the first device of equipment and the second device of equipment with respect to a component of the pool or spa system based at least in part on the first set of characteristics and the second set of characteristics Other embodiments of this aspect include corresponding computer systems, apparatus, and computer programs recorded on one or more computer storage devices, each configured to perform the actions of the methods.

### BRIEF DESCRIPTION OF THE DRAWINGS

The accompanying drawings, which are incorporated into and constitute a part of this specification, illustrate one or more certain examples and, together with the description of the example, serve to explain the principles and implementations of the certain examples.

FIG. 1 illustrates a pool system for geolocation of devices of pool or spa equipment and for multimode network communications, according to at least one example.

FIG. 2 illustrates a pool system for geolocation of devices of pool or spa equipment, according to at least one example.

FIG. 3 illustrates a flow chart depicting an example process for geolocation of devices of pool or spa equipment, according to at least one example.

FIG. 4 illustrates a pool system for multimode network communications, according to at least one example.

FIG. 5 illustrates a flow chart depicting an example process for multimode network communications, according to at least one example.

FIG. 6 illustrates examples of a computer system for implementing the example processes, according to at least one example.

### DETAILED DESCRIPTION

Examples described herein relate to systems, devices, and techniques for geolocation of devices of pool or spa equipment and systems, devices, and techniques for multimode communication between the devices of pool or spa equipment and a pool automation controller, and between the pool automation controller and a network router of a home network.

A pool automation controller may be configured to geolocate components of a pool or spa system that is deployed in a given area. These techniques may be helpful during initial deployment of the system, when adjustments to the system are made, and at other times during the lifecycle of the system. To enable geolocation, each device of pool equipment may include or be associated with a wireless communication device and the pool automation controller may include a corresponding controller wireless communication device (e.g., a wireless radio, a reader device, and/or any other similar such device). Generally, the pool automation controller may communicate in some manner with the devices of pool equipment to identify presence of the devices of pool equipment and identify a relative location of the devices of pool equipment based on various signal characteristics and/or processing algorithms. In some examples, the relative location of the devices may be helpful alone, or when combined with other information (e.g., data about system layout and pool pad), to establish mapping relationships between devices (e.g., a first valve is further from the pool automation controller relative to a second valve, each of which are included in the same run of pipe).

Turning now to a first particular example, in this example, each device of pool equipment may be outfitted with a wireless communication device that is an active device (e.g., Bluetooth low energy (BLE) devices, ultra-wideband (UWB) devices, Wi-Fi devices, etc.) that enables two-communication with a corresponding controller wireless communication device (e.g., a wireless radio) that is included in a pool automation controller. The pool automation controller may send wireless communications to the various wireless communications devices. These wireless communications may correspond to the appropriate standard/protocol of the wireless communications devices. The wireless communications devices may send back return communications. These communications can be used by the pool automation controller to derive a relative distance between each device of pool equipment and the pool automation controller. For example, timing information relating to the return communications may be correlated to relative distances. By comparing the various relative distances, the pool automation controller may be capable of deriving an overall relative system map. In some examples, the pool automation controller may be configured to determine approximate locations of the devices of pool equipment (e.g., distance and geolocation) by using other information derived from the communications or from other sources and/or by using other signal processing algorithms. For example, the wireless radio (e.g., a Wi-Fi radio) may be paired with multiple antennas and/or the pool automation controller may include multiple corresponding wireless radios, and may be configured to perform triangulation techniques using the communications. In some examples, additional information, such as knowledge about which devices are digitally connected to the pool automation controller, devices that are plugged into ports of the pool automation controller, devices that are receiving power from a relay, etc., may be used to generate the representation of the pool or spa system.

Turning now to a second particular example, in this example, each device of pool equipment may be outfitted with a wireless communication device that is a passive device (e.g., near field communication (NFC) tag, ultra-high frequency (UHF) tag, etc.) that outputs wireless signals, which are received by the corresponding controller wireless communication device (e.g., a reader device). The pool automation controller may use the reader device to read wireless signals output by the passive devices, which may be used to confirm the presence of a corresponding device and/or identify location. Depending on characteristics of these signals, the pool automation controller to derive a relative distance between each device of pool equipment and the pool automation controller. By comparing the various relative distances, the pool automation controller may be capable of deriving an overall relative system map. In some examples, the pool automation controller may be configured to determine approximate locations of the devices of pool equipment (e.g., distance and geolocation) by using other information retrieved from the signals and/or from other sources. For example, the pool automation controller may use the relative locations/distances in combination with a system topology layout to effectively associate each unique device of pool equipment with an element of the system topology layout. In some examples, additional information, such as knowledge about which devices are digitally connected to the pool automation controller, devices that are plugged into ports of the pool automation controller, devices that are receiving power from a relay, etc., may be used to generate the representation of the pool or spa system.

Turning now to a third particular example, a pool automation controller may include a controller wireless communication device that is a multimode wireless radio. That multimode wireless radio may support at least two modes and may connect the pool automation controller to various components via the Internet Protocol (IP) such as Wi-Fi. For instance, the multimode wireless radio can communicate on a first Wi-Fi network with the devices of pool equipment and a second Wi-Fi network with a router of an entity system. In this manner, the multimode wireless radio may function as an access point for the devices of pool equipment and as a client/station device with respect to the router. The entity system may be a home, a business, or another location associated with the pool or spa system. The router can connect the pool automation controller to the Internet and a distributed computing environment (e.g., the cloud). The first network and the second network may both be Internet Protocol (IP)-based networks, and at least the first network can be a private network. So, by using a single multimode wireless radio (e.g., a single multimode chip) in the pool automation controller, the pool automation controller can connect to both the entity system and the pool equipment, thereby supporting at least two networks, which may operate simultaneously.

In the interest of clarity, not all of the routine features of the examples described herein are shown and described. It will, of course, be appreciated that in the development of any such actual implementation, numerous implementation-specific decisions must be made in order to achieve the developer's specific goals, such as compliance with application- and business-related constraints, and that these specific goals will vary from one implementation to another and from one developer to another.

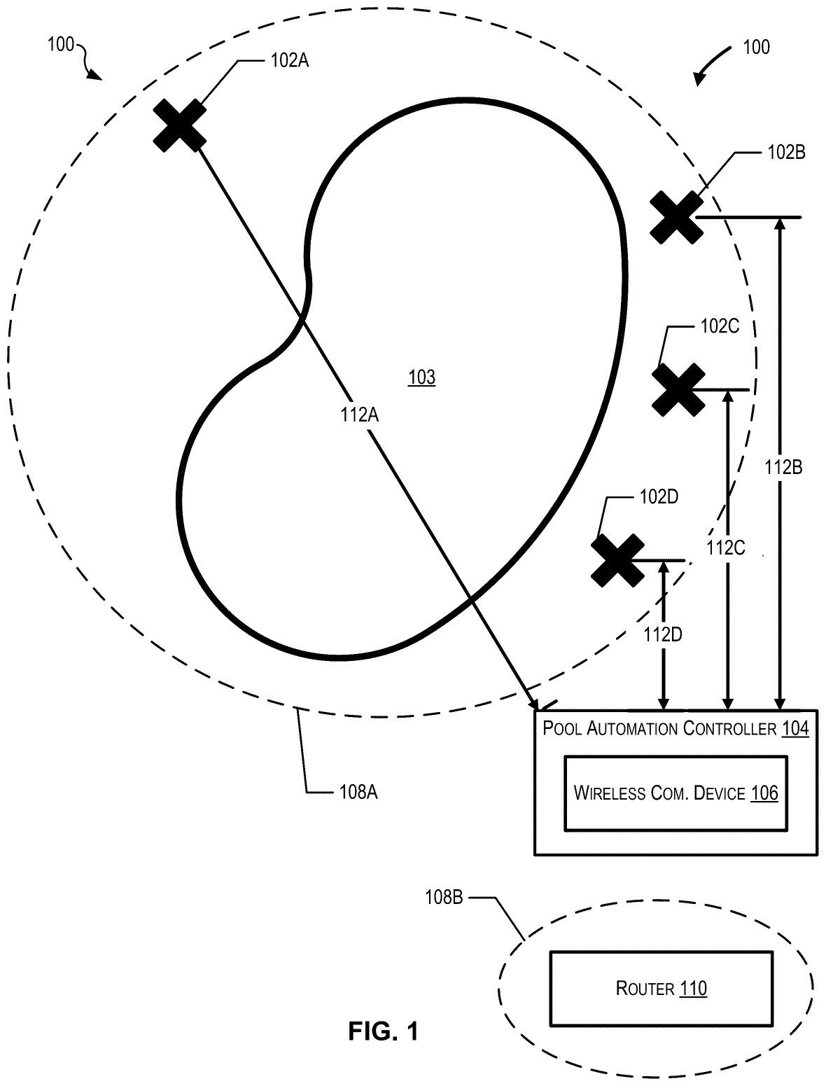

Turning now to the figures, FIG. 1 illustrates a pool system for geolocation of devices of pool or spa equipment and for multimode network communications, according to at least one example. Discussion of a “pool” system and corresponding “pool” devices and the like may be equally applicable to spa systems, water feature systems, and any other body of water could be operated by a water control system.

The pool system 100 may be deployed at a pool location that includes a pool 103 or other body of water. In some examples, the pool location may be referred to generally as the pool “pad,” which means any suitable location, either indoors or outdoors, at which the pool system 100 is deployed. In some examples, the pool pad may be located adjacent to the pool 103. The pool system 100 may include any suitable number of pool devices 102 and a pool automation controller 104. The pool devices 102 may be devices of pool equipment that are deployed to perform different functions in the pool system 100. For example, the pool devices 102 may include valves, heaters, pumps, sensors, and the like. In some examples, the pool devices 102 may be powered and/or controlled by the pool automation controller 104. For example, a power box may be deployed together with the pool automation controller 104, and the power box may include electrical relays and/or electrical ports for powering the pool devices 102. In some examples, the pool automation controller 104 may include a wired digital connection with the pool devices 102 via a serial interface such as an RS-485 interface. This may enable the pool automation controller 104 to send control signals to the pool devices 102 to effectuate certain functions.

The pool automation controller 104, which will be described in more detail herein, may include a wireless communication device 106. The wireless communication device 106 may be separate from other network interfaces such as the serial interface described herein. Generally, the wireless communication device 106 may be multimodal and configured to enable the pool automation controller 104 to communicate with corresponding wireless communication devices that are associated with or otherwise incorporated into the pool devices 102 and a router 110.

The communication with the pool devices 102 may occur via a first network 108A and the communication with the router 110 may occur via a second network 108B. In some examples, the first network 108A is private wireless network in which the wireless communication device 106 operates in a first mode as an access point for the pool devices 102. In some examples, the second network 108B is a private or public wireless network in which the wireless communication device 106 operates in a second mode as a client device with respect to the router 110. The second network 108B may be a home network such as a wideband local area network of an operator of the pool system 100. In some examples, the second network 108B may be useable by the pool automation controller 104 to access the Internet and other remotely accessible resources. In some examples, both modes may be Internet Protocol (IP) based. In this example, the wireless communication device 106 may be a single wireless chip that enables both modes.

As described herein, the pool automation controller 104 may also be configured to communicate with the various pool devices 102 in order to determine relative distances of each of these devices 102 with respect to the pool automation controller 104 and/or the wireless communication device 106. In this example, the wireless communication device 106 may be configured to match or otherwise be enabled to communicate with the type(s) of corresponding wireless communication devices of the pool devices 102. For example, the wireless communication device 106 may be characterized as an active such as Bluetooth radio, an Ultra-Wide Band radio, a Near Field Communication device, a Wi-Fi radio, and the like which can facilitate two-way communications with the pool devices 102 to derive information about locations of the pool devices 102. In some examples, the wireless communication device 106 may service passive devices via Near Field Communication protocols or other communication protocols.

In some examples, characteristic information associated with the communications (e.g., time of arrival, direction of arrival, signal quality, angle of arrival, time difference of arrival, angle of departure, signal strength, and the like) may be used to estimate a relative location of the pool device 102 with respect to other devices and/or the pool automation controller 104. For example, such information may be used to determine that the pool device 102D is closer to the pool automation controller 104 than all other pool devices 102 and that the pool device 102A is the furthest from the pool automation controller 104. In some examples, in addition to the relative location, the system 100 may be used to determine more precise location of the pool devices 102 (e.g., accuracy of between 1 and 10 meters, between 10 and 20 meters, between 20 and 30 meters, or less than 1 meter), which can be represented in any suitable manner (e.g., as a set of straight-line distances 112, a set of coordinates, a set of headings and directions, etc.). In some examples, deriving or otherwise determining the precise locations of the pool device 102 may include using other information available to the pool automation controller 104, as described herein. The information about the relative distances and/or precise location may be recorded by the pool automation controller 104 and used to populate a digital system map or the like, such as the illustration in FIG. 1. The digital system map may be presented on a user interface of the pool automation controller 104 and/or a connected user device.

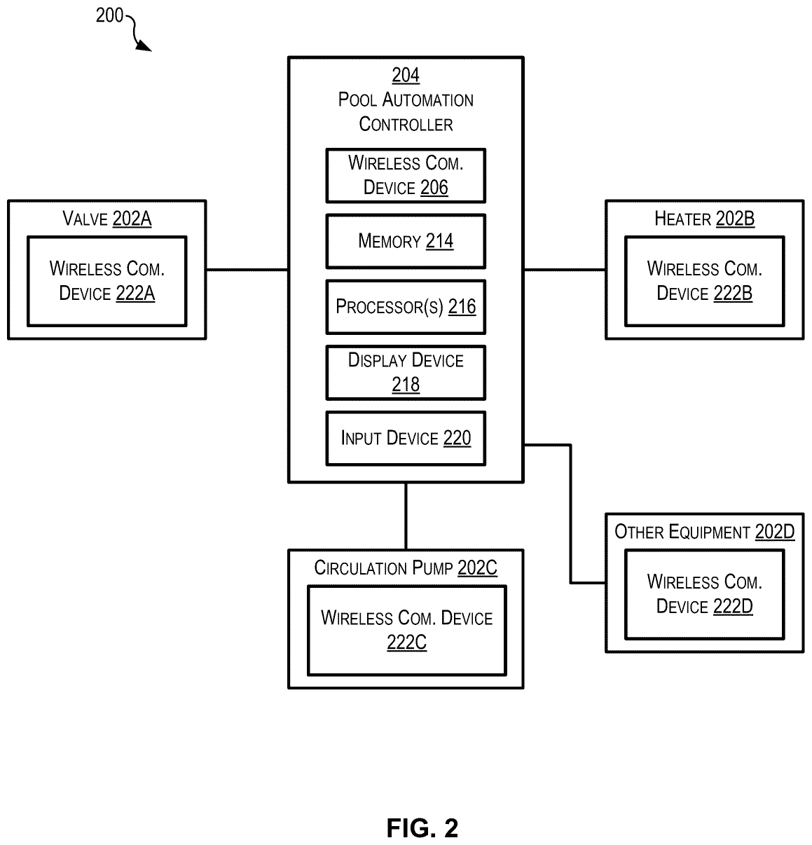

FIG. 2 illustrates a pool system 200 for geolocation of devices of pool or spa equipment, according to at least one example. The pool system 200 is an example of the pool system 100. The pool system 200 includes a pool automation controller 204 (e.g., the pool automation controller 104) which is configured to communicate with various pool devices such as a valve actuator 202A (e.g., a pool device 202), a heater 202B (e.g., a pool device 202), a circulation pump 202C (e.g., a pool device 202), and other equipment 202D (e.g., a pool device 202). The other equipment 202D may include additional pumps, valve actuators, heaters, sensors, chlorinators, lights, etc.

The pool automation controller 204 may include a wireless communication device 206 (e.g., the wireless communication device 106), a memory 214, one or more processors 216, a display device 218, an input device 220, and any other suitable components to enable the techniques described herein.

The wireless communication device 206 may be selected and/or configured to implement the particular techniques described herein. For example, the wireless communication device 206 may enable shortrange communications with corresponding active and/or passive devices on the devices 202 and/or may enable multiple modes to communicate with the devices 202 and a router or other access point.

The memory 214 may be any suitable memory as is known in the art. The memory 214 may be non-transitory and may be configured to store computer-executable instructions (e.g., program code) to enable the techniques described herein, e.g., with respect to the flowcharts. The processor(s) 216 may be configured to access the memory 214 and execute the stored therein computer-executable instructions to perform the techniques described herein. The display device 218 may be included in the pool automation controller 204 and/or connected to the pool automation controller 204 in any suitable manner. The display device 218 may be configured to present information relating to the techniques described herein. For example, the display device 218 may be used to present a system map that includes one or more devices 202 and which has been determined or otherwise derived using the techniques described herein. The input device 220 may be any suitable input device configured to receive inputs to control, select, execute, or otherwise interact with the pool automation controller 204.

Each of the devices 202 may also include a wireless communication device 222A-222D. The type and configuration of the wireless communication device 222 may depend on the embodiment described herein and which type of wireless communication device 206 is selected. For example, the wireless communication devices 222 may be active devices such as Bluetooth chips, UWB chips, Wi-Fi chips, etc.; passive devices such as Near Field Communication (NFC) tags, Ultra High Frequency (UHF) tags, etc.; and any other suitable device or tags to enable communication with the pool automation controller.

As introduced herein, the pool automation controller 204 can determine relative locations of the devices 202 using various techniques relating to signal strength, triangulation, and the like. Such techniques may include using Received Signal Strength Indicator (RSSI) measurements from connected devices, signal and response techniques, and the like. To do so, devices 202 may be physically associated with one of the wireless communication devices 222. The wireless communication devices 222 may uniquely identify the valve actuator 202A, the heater 202B, the circulation pump 202C, and the other devices of equipment 202D, respectively. For instance, the wireless communication device 222A can be associated with a unique identifier of the valve actuator 202A and the wireless communication device 222B can be associated with a unique identifier of the heater 202B, and so on and so forth for other devices 202. The other equipment 202D can also include corresponding wireless communication devices 222D.

The pool automation controller 204 can use the wireless communication device 206 to communicate with the wireless communication devices 222 and to determine relative locations of the devices 202. In some instances, the wireless communication device 206 may transmit a signal that activates chips in the wireless communication devices 222. The wireless communication devices 222 may then transmit signals back to the pool automation controller 204. Alternatively, the wireless communication devices 222 may transmit signals to the pool automation controller 204 without first receiving a signal from the pool automation controller 204. The transmitted signals may include the characteristic information about the devices 202 (e.g., unique identifiers) and other information about the signals. For instance, the wireless communication device 222B may transmit a signal to the pool automation controller 204 that includes the identifier of the heater 202B and information about the temperature of the pool or spa. The information may include a temperature setting for the heater 202B, a current temperature of the pool or spa, etc.

The same signal from the pool automation controller 204 may activate the wireless communication devices 222 of each of the devices. So, based on a timing of the pool automation controller 204 receiving a response signal from the devices, the pool automation controller 204 can localize the devices. For example, the heater 202B may be ten feet from the pool automation controller 204 and the circulation pump 202C may be twenty feet from the pool automation controller 204. So, since the signals to and from the heater 202B have a shorter distance to travel, the pool automation controller 204 can receive the response signal from the heater 202B before receiving the response signal from the circulation pump 202C. As a result, the pool automation controller 204 can determine that the heater 202B is located closer to the pool automation controller 204 than the circulation pump 202C.

In some examples, the pool automation controller 204 may be able to determine a more precise location of the devices. For instance, based on the difference in the timing of the received response signals, the pool automation controller 204 may be able to determine the distance that each device is from the pool automation controller 204 (e.g., that the heater 202B is ten feet away and the circulation pump 202C is twenty feet away). In addition, characteristics like angle of arrival of the response signals may allow the pool automation controller 204 to triangulate the locations of the devices relative to each other. In some examples, the pool automation controller 204 may include multiple wireless communication devices 206 and/or multiple antennas to enable triangulation techniques for identifying precise locations of the 202.

Using the location information about the devices, as well as additional information about the pool system 200, the pool automation controller 204, or a different computing device in communication with the pool automation controller 204, can generate a representation of the pool system 200. For example, the pool automation controller 204 may send the location information related to the valve actuator 202A, the heater 202B, the circulation pump 202C, and the other equipment 202D to a computing device. The pool automation controller 204 may also send an indication of the devices that are connected to the pool automation controller 204 and how the devices are connected (e.g., via ports, wirelessly, etc.) to the computing device. Alternatively, the computing device may receive the additional information via user input and not directly from the pool automation controller 204. In any case, based on the location information and the additional information, the computing device can build out the representation of the pool system 200, showing the equipment, their relative distances to the pool automation controller 204, and their connection to the pool automation controller 204.

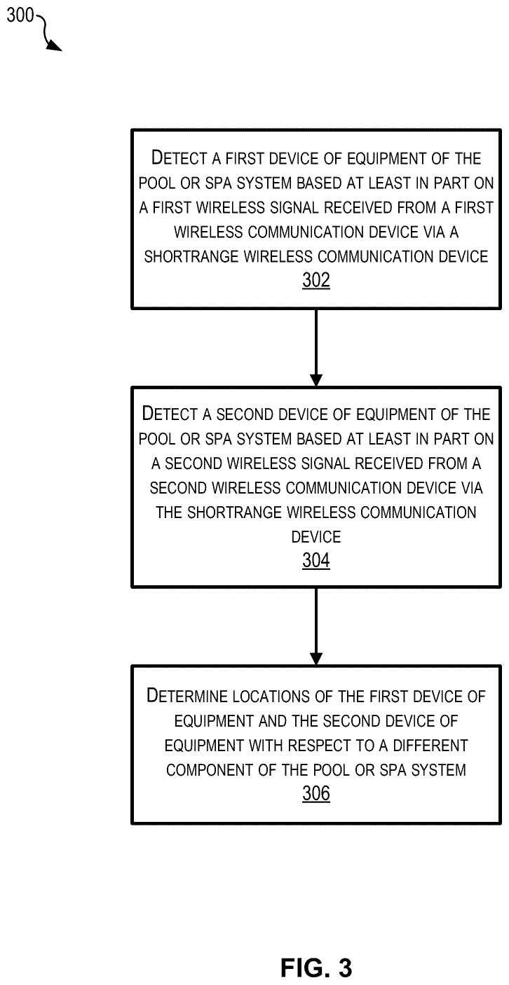

FIG. 3 illustrates a flow chart depicting an example process 300 for geolocation of devices of pool or spa equipment, according to at least one example. This process, and any other processes described herein, is illustrated as a logical flow diagram, each operation of which represents a sequence of operations that can be implemented in hardware, computer instructions, or a combination thereof. In the context of computer instructions, the operations may represent computer-executable instructions stored on one or more non-transitory computer-readable storage media that, when executed by one more processors, perform the recited operations. Generally, computer-executable instructions include routines, programs, objects, components, data structures, and the like that perform particular functions or implement particular data types. The order in which the operations are described is not intended to be construed as a limitation, and any number of the described operations can be combined in any order and/or in parallel to implement the process.

Additionally, some, any, or all of the processes described herein may be performed under the control of one or more computer systems configured with specific executable instructions and may be implemented as code (e.g., executable instructions, one or more computer programs, or one or more applications) executing collectively on one or more processors, by hardware, or combinations thereof. As noted above, the code may be stored on a non-transitory computer-readable storage medium, for example, in the form of a computer program including a plurality of instructions executable by one or more processors.

The process 300 is performed by a pool automation controller (e.g., the pool automation controller 104 of FIG. 1), as implemented using components of the pool system 200 and/or the computer system 600. The process 300 in particular relates to a process of identifying and geolocating devices of equipment within some geographic region. The geographic region may correspond to the extents of the pool system, e.g., may relate to equipment on the pool or spa pad. In some examples, the distance between the pool automation controller and the furthest device of equipment that can be identified may depend on the type of communication devices (e.g., radios, antennas, and the like) and communication protocols used.

In some examples, multiple different protocols may be used by the pool automation controller to identify different devices of equipment. Selecting the appropriate protocol may depend on a variety of factors, some of which may be accessible to the pool automation controller (or provided via a network connection or as a user input as a user interface) when picking the appropriate protocol. For example, a first device of equipment may include a Bluetooth radio and the pool automation controller may select its corresponding Bluetooth radio to communicate with the first device. A second device may be identifiable using an Ultra-Wide Band (UWB) technology. In this example, the pool automation controller may select its UWB radio to communicate with the second device. The results of the communications with the first and second devices may be compared to determine relative and/or precise locations of the first and second devices.

In some examples, both Bluetooth and UWB may be suitable for shortrange communication (e.g., not exceeding 100-200 meters) and may use various techniques for high precision positioning. For example, Bluetooth may utilize Received Signal Strength Indicator (RSSI) and angle of arrival (AoA) to provide localization, while UWB may use time of flight (ToF) and time of difference of arrival (TDoA) measurements.

In some examples, the pool automation controller may include a shortrange wireless communication device that includes an antenna and/or any suitable reader for performing the techniques described herein. For example, such a reader may include an NFC reader, a UWB reader, a Bluetooth reader, and the like.

The process 300 begins at block 302 by the pool automation controller detecting a first device of equipment of a pool or spa system based at least in part on a first wireless signal received from a first wireless communication device via a shortrange wireless communication device. The first wireless communication device may be a first radio tag, antenna, radio, etc. The pool or spa system may be deployed within a defined region such as a pool pad. The first wireless signal may include a first set of characteristics. The first set of characteristics may pertain to any suitable value, measure, or the like relating to characteristics of the first wireless signal. In some examples, detecting the first device may include the pool automation controller sending an interrogation signal that is received and responded to by the first device.

At block 304, the process 300 includes the pool automation controller detecting a second device of equipment of the pool or spa system based at least in part on a second wireless signal received from a second wireless communication device via the shortrange wireless communication device. The second wireless signal may include a second set of characteristics of the same type and variety as the first set of characteristics or different. For example, the first wireless signal and the second wireless signal may correspond to different standards, protocols, etc., and therefore the characteristics of these signals may differ. The pool automation controller may be configured to process different signals from different devices to perform the techniques described herein.

In some examples, first wireless communication device may include a first wireless tag and the first and the second wireless communication device may include a second wireless tag. In some examples, the first and second wireless tags may operate according to the same or different communication protocols. For example, any of the wireless tags may operate according to any one of UWB, UHF, NFC, Wi-Fi, Bluetooth, or the like.

In some examples, the first set of characteristics and/or the second set of characteristics may include at least one of first time of arrival information for the respective wireless signal, first angle of arrival information for the respective wireless signal, or first time difference of arrival information for the respective wireless signal.

In some examples, the first wireless communication device may include a first shortrange communication device of a same type as the shortrange wireless communication device. In some examples, the shortrange wireless communication device may include a plurality of antennas. In this example, the first set of characteristics may include first received signal strength indicator information for the first wireless signal and the second set of characteristics may include second received signal strength indicator information for the second wireless signal. In this example, the operation at block 306 may include triangulation and the first and second set of characteristics to determine locations of the first device of equipment and the second device of equipment.

In some examples, a first location of the first device of equipment determined at block 306 is relative to a second location of the second device of equipment determined at block 306. For example, such relative relationship may indicate that one device of equipment is further from the different component of the pool or spa system (e.g., a pool automation controller, an antenna associated with the pool automation controller, or any other suitable system component), as compared to the location of the other device of equipment.

In some examples, the process 300 may further include identifying a first type of the first device based at least in part on the first set of characteristics, identifying a second type of the second device based at least in part the second set of characteristics, and updating a record for the pool or spa system based at least in part on the identified first type and the identified second type. The record (e.g., location information, whether or not associated with specific aspects of the pool or spa system) may be presented in a user interface of a pool automation controller, at a connected user interface, and the like.

In some examples, the process 300 may further include generating location information corresponding to the locations of the first device and the second device, and providing the location information for presentation at a display of a pool automation controller or a user device in network communication with the pool automation controller.

In some examples, the first wireless signal and/or the second wireless signal may include a Wi-Fi signal received via a Wi-Fi network. This may allow for Wi-Fi positioning, which may rely on RSSI measurements, fingerprinting, ToF methods, and the like, to estimate a device's location. In some examples, the pool automation controller may include any suitable algorithm for processing signals described herein in order to perform block 306.

In some examples, the locations of the first device of equipment and the second device of equipment are with respect to the pool automation controller communicatively coupled with the shortrange wireless communication device. In some examples, the locations of the first device of equipment and the second device of equipment are unique geographic locations with respect to a pool pad.

In some examples, the shortrange wireless communication device is configured to communicate using one or more of an ultra-wideband protocol, a Bluetooth protocol, a near field communication protocol, or an Internet protocol. In some example, the process 300 may further include, at least prior to receiving the first wireless signal, sending, using the multimode wireless radio, a third wireless signal to the first wireless communication device, the third wireless signal configured to cause the first wireless communication device to send the first wireless signal.

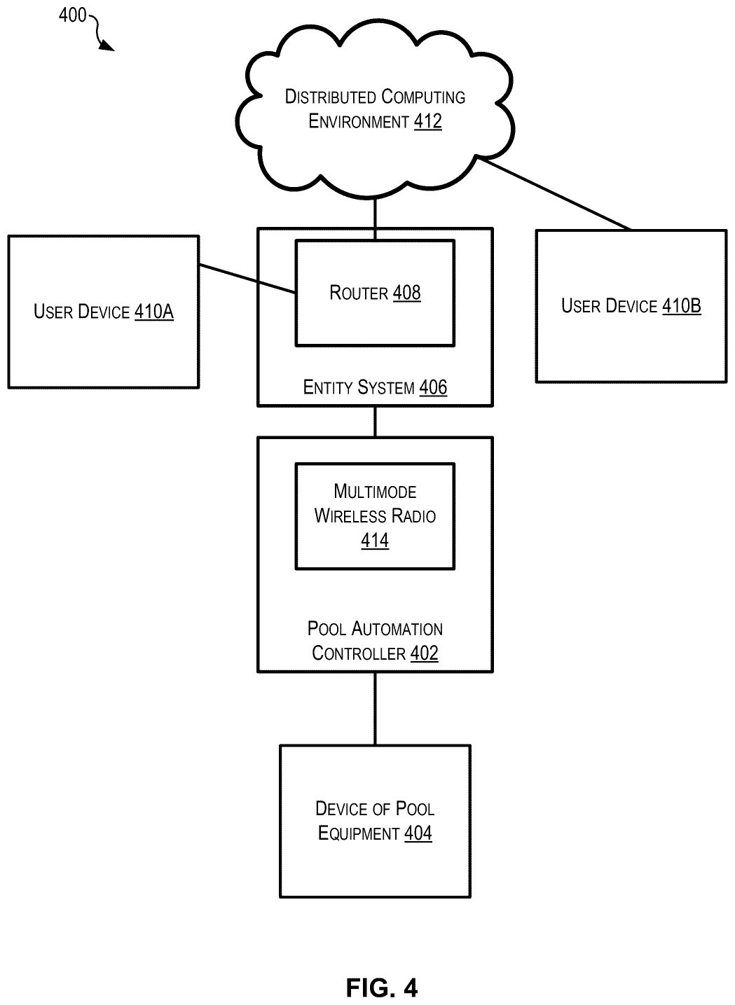

FIG. 4 illustrates a pool system 400 for multimode network communications, according to at least one example. The pool system 400 includes a pool automation controller 402, devices of pool equipment 404, and an entity system 406. The pool equipment 404 can include devices that control or monitor settings and factors associated with the pool or spa system. The pool equipment 404 may be distributed among a pool pad, as described herein. For instance, the pool equipment 404 can include one or more heaters, pumps, sensors, lights, chlorinators, etc. The entity system 406 is a set of network devices associated with a location that includes the pool or spa system. For example, the entity system 406 may be devices associated with a house at which the pool or spa system is located. The devices may include a router 408 and a local user device 410A. The local user device 410A may be connected to the pool automation controller 402 via the router 408 of the entity system (e.g., on a local area network). The pool system 400 may also enable a remote user device 410B to connect to the pool automation controller 402 via a distributed computing environment 412 (e.g., the Cloud), which may be accessible via the Internet.

As illustrated, the pool automation controller 402 includes a multimode wireless radio 414. The multimode wireless radio 414 enables the pool automation controller to maintain connections with devices over two different wireless networks. The multimode wireless radio 414 may include a Wi-Fi module that allows communication in two different modes. For example, in a first mode, the multimode wireless radio 414 functions as an access point for the pool equipment 404 that connect to the pool automation controller 402. In a second mode, the multimode wireless radio 414 functions as a station, client device with respect to the entity system 406, which includes the router 408 that operates as an end point in a networking sense (like the multimode wireless radio 414 in the first operating mode).

Both of the networks described herein can be IP-based. In addition, the network established for the pool equipment 404 may be a private network. The network established for the router 408 may be a private or public network. Accordingly, the pool automation controller 402 can act as an access point for the pool equipment 404, but can also act as a station, or client, to the router 408. As such, the pool automation controller 402 is connected to the Internet via the router 408 and can simultaneously communicate with the pool equipment 404.

The connection to the router 408 can provide the pool automation controller 402 with access to the distributed computing environment 412. The remote user device 410B or application of the second network may be able to connect directly to the pool automation controller 402 or via the distributed computing environment 412. As such, the pool automation controller 402 may be able to access or store information about the pool equipment 404 from or in the distributed computing environment 412 by using the multimode wireless radio 414. For instance, the distributed computing environment 412 may store settings used previously by the pool equipment 404 or for similar pool systems. The pool automation controller 402 can access the distributed computing environment 412 to lookup the used settings and determine which settings are to be used by the pool equipment 404. The pool automation controller 402 can then send commands to the pool equipment 404 indicating the settings that are to be used (e.g., over the network).

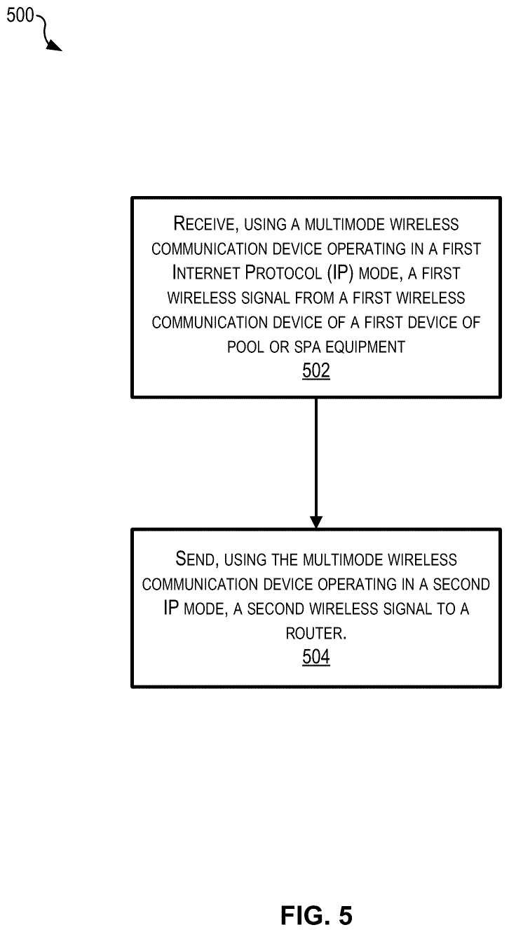

FIG. 5 illustrates a flow chart depicting an example process 500 for multimode network communications, according to at least one example. The process 500 is performed by a pool automation controller (e.g., the pool automation controller 402 of FIG. 4, the pool automation controller 104, the pool automation controller 204).

The process 500 begins at block 502 by the pool automation controller receiving, using a multimode wireless communication device operating in a first Internet Protocol (IP) mode, a first wireless signal from a first wireless communication device of a first device of pool or spa equipment.

In some examples, this may include providing, via the multimode wireless communication device, a first wireless connection with the first device of pool or spa equipment via a first IP-based network. For example, the multimode wireless communication device can provide an access point for the pool equipment to the first IP-based network. Accordingly, the pool automation controller can communicate with the pool equipment over the first IP-based network when the multimode wireless communication device operates in the first IP mode.

In some examples, the first IP mode may include an access point mode when receiving the first wireless signal and the second IP mode may include a client communication mode. In some examples, the device of pool or spa equipment may include at least one of a pump, a heater, or a chlorinator.

At block 504, the process 500 includes the pool automation controller sending, using the using the multimode wireless communication device operating in a second IP mode, a second wireless signal to a router.

In some examples, this may include providing, via the multimode wireless communication device, a second wireless connection to the router of an entity system via a second IP-based network. The second IP-based network can connect the pool automation controller to the Internet and/or a distributed computing environment via the router and thereby send the second wireless signal. Thus, the pool automation controller can store information about the pool equipment in the distributed computing environment.

In some examples, receiving the first wireless signal from the first wireless communication device may include receiving the first wireless signal via a first Wi-Fi network. In some examples, receiving the second wireless signal from the second wireless communication device may include receiving the first wireless signal via a second Wi-Fi network. The first Wi-Fi network may be distinct from the second Wi-Fi network. In some examples, the first Wi-Fi network may include a first network connections between a plurality of devices of pool or spa equipment and the multimode wireless radio and the second Wi-Fi network may include a second network connection between the multimode wireless radio and the router.

In some examples, the multimode wireless communication device may include a wireless chip configured to operate in multiple modes.

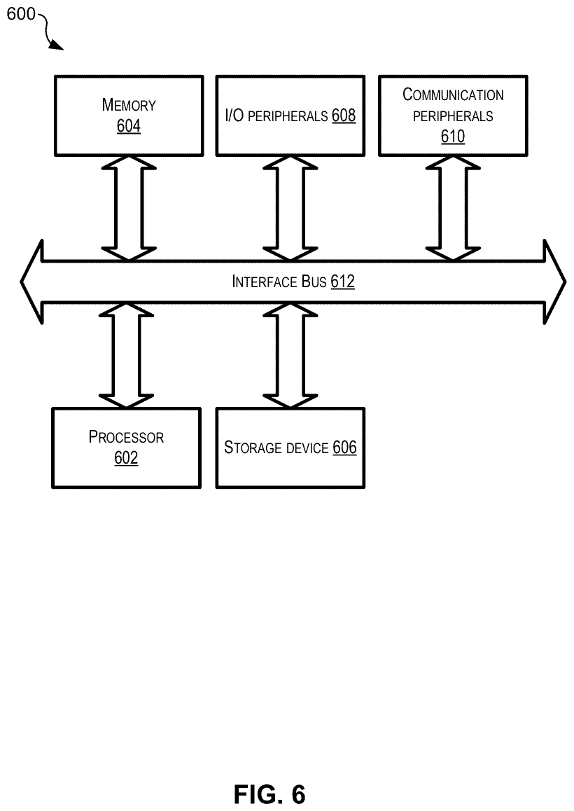

FIG. 6 illustrates examples of a computer system for implementing the example processes, according to at least one example. The computer system 600 may be a single computer such as a user computing device and/or can represent a distributed computing system such as one or more server computing devices. The computer system 600 is an example of the external computing devices, processing circuitry, controllers and/or microcontrollers of pool equipment and/or the pool automation controller 104, 204, 402, and the like.

The computer system 600 may include at least a processor 602, a memory 604, a storage device 606, input/output peripherals (I/O) 608, communication peripherals 610, and an interface bus 612. The interface bus 612 is configured to communicate, transmit, and transfer data, controls, and commands among the various components of the computer system 600. The memory 604 and the storage device 606 include computer-readable storage media, such as Random Access Memory (RAM), Read ROM, electrically erasable programmable read-only memory (EEPROM), hard drives, CD-ROMs, optical storage devices, magnetic storage devices, electronic non-volatile computer storage, for example Flash® memory, and other tangible storage media. Any of such computer-readable storage media can be configured to store instructions or program code embodying aspects of the disclosure. The memory 604 and the storage device 606 also include computer-readable signal media. A computer-readable signal medium includes a propagated data signal with computer-readable program code embodied therein. Such a propagated signal can take any of a variety of forms including, but not limited to, electromagnetic, optical, or any combination thereof. A computer-readable signal medium includes any computer-readable medium that is not a computer-readable storage medium and that can communicate, propagate, or transport a program for use in connection with the computer system 600.

Further, the memory 604 may include an operating system, programs, and applications. The processor 602 is configured to execute the stored instructions and includes, for example, a logical processing unit, a microprocessor, a digital signal processor, and other processors. The memory 604 and/or the processor 602 can be virtualized and can be hosted within another computing system of, for example, a cloud network or a data center. The I/O peripherals 608 may include user interfaces, such as a keyboard, screen (e.g., a touch screen), microphone, speaker, other input/output devices, and computing components, such as graphical processing units, serial ports, parallel ports, universal serial buses, and other input/output peripherals. The I/O peripherals 608 are connected to the processor 602 through any of the ports coupled to the interface bus 612. The communication peripherals 610 are configured to facilitate communication between the computer system 600 and other computing devices over a communications network and include, for example, a network inference controller, modem, wireless and wired interface cards, antenna, and other communication peripherals.

A collection of exemplary embodiments is provided below, including at least some explicitly enumerated as “Examples” providing additional description of a variety of example embodiments in accordance with the concepts described herein. These examples are not meant to be mutually exclusive, exhaustive, or restrictive; and the disclosure is not limited to these examples but rather encompasses all possible modifications and variations within the scope of the issued claims and their equivalents.

Example 1. In this example, there is provided a pool or spa system configured for automated identification of pool or spa equipment, the system comprising:
a plurality of devices of equipment distributed among an area, a first device of equipment of the plurality of devices of equipment comprising a first wireless communication device and a second device of equipment of the plurality of devices of equipment comprising a second wireless communication device; and
pool automation controller comprising:
a shortrange wireless communication device configured to communicate with the first wireless communication device and the second wireless communication device;
a memory configured to store computer-executable instructions; and
one or more processors configured to access the memory and execute the computer-executable instructions to at least:
receive, using the shortrange wireless communication device, a first wireless signal from the first wireless communication device, the first wireless signal comprising a first set of characteristics;
receive, using the shortrange wireless communication device, a second wireless signal from the second wireless communication device, the second wireless signal comprising a second set of characteristics; and
determine locations within the area of the first device and the second device with respect to the pool automation controller based at least in part on the first set of characteristics and the second set of characteristics.

Example 2. In this example, there is provided a pool or spa system of any or preceding or subsequent examples, wherein the first wireless communication device comprises a first wireless tag and the first and the second wireless communication device comprises a second wireless tag.

Example 3. In this example, there is provided a pool or spa system of any or preceding or subsequent examples, wherein the first wireless tag operates according to a first communication protocol and the second wireless tag operates according to a second communication protocol that is distinct from the first wireless communication protocol.

Example 4. In this example, there is provided a pool or spa system of any or preceding or subsequent examples, wherein the first set of characteristics comprises at least one of first time of arrival information for the first wireless signal, first angle of arrival information for the first wireless signal, or first time difference of arrival information for the first wireless signal.

Example 5. In this example, there is provided a pool or spa system of any or preceding or subsequent examples, wherein the first wireless communication device comprises a first shortrange communication device of a same type as the shortrange wireless communication device.

Example 6. In this example, there is provided a pool or spa system of any or preceding or subsequent examples, wherein the shortrange wireless communication device comprises a plurality of antennas, and wherein the first set of characteristics comprises first received signal strength indicator information for the first wireless signal and the second set of characteristics comprises second received signal strength indicator information for the second wireless signal.

Example 7. In this example, there is provided a pool or spa system of any or preceding or subsequent examples, wherein determining the locations of the first device and the second device comprises using triangulation and the first and second set of characteristics.

Example 8. In this example, there is provided a pool or spa system of any or preceding or subsequent examples, wherein a first location of the first device is relative to a second location of the second device.

Example 9. In this example, there is provided a computer-implemented method for automated identification of pool or spa equipment of a pool or spa system, the method comprising:
detecting a first device of equipment of the pool or spa system based at least in part on a first wireless signal received from a first wireless communication device via a shortrange wireless communication device, the first wireless signal comprising a first set of characteristics;
detecting a second device of equipment of the pool or spa system based at least in part on a second wireless signal received from a second wireless communication device via the shortrange wireless communication device, the second wireless signal comprising a second set of characteristics; and
determine locations of the first device of equipment and the second device of equipment with respect to a different component of the pool or spa system based at least in part on the first set of characteristics and the second set of characteristics.

Example 10. In this example, there is provided a method of any or preceding or subsequent examples, further comprising:
identifying a first type of the first device based at least in part on the first set of characteristics;
identifying a second type of the second device based at least in part the second set of characteristics; and
updating a record for the pool or spa system based at least in part on the identified first type and the identified second type.

Example 11. In this example, there is provided a method of any or preceding or subsequent examples, further comprising:
generating location information corresponding to the locations of the first device and the second device; and
providing the location information for presentation at a display of the pool automation controller or a user device in network communication with the pool automation controller.

Example 12. In this example, there is provided a method of any or preceding or subsequent examples, wherein at least one of the first wireless signal or the second wireless signal comprises a first Wi-Fi signal received via a first Wi-Fi network.

Example 13. In this example, there is provided a method of any or preceding or subsequent examples, wherein the locations of the first device of equipment and the second device of equipment are with respect to the pool automation controller communicatively coupled with the shortrange wireless communication device.

Example 14. In this example, there is provided a method of any or preceding or subsequent examples, wherein the locations of the first device of equipment and the second device of equipment are unique geographic locations with respect to a pool pad.

Example 15. In this example, there is provided a method of any or preceding or subsequent examples, wherein the shortrange wireless communication device is configured to communicate using one or more of a ultra-wideband protocol, a Bluetooth protocol, a near field communication protocol, or an Internet protocol.

Example 16. In this example, there is provided a pool automation controller for a pool or spa system configured for automated identification of pool or spa equipment, the pool automation controller comprising:
a shortrange wireless communication device configured to communicate with a plurality of wireless communication devices;
a memory configured to store computer-executable instructions; and
one or more processors configured to access the memory and execute the computer-executable instructions to at least:
receive, using the shortrange wireless communication device, a first wireless signal from a first wireless communication device of a first device equipment, the first wireless signal comprising a first set of characteristics;
receive, using the shortrange wireless communication device, a second wireless signal from a second wireless communication device of a second device of equipment, the second wireless signal comprising a second set of characteristics; and
determine locations of the first device of equipment and the second device of equipment with respect to a component of the pool or spa system based at least in part on the first set of characteristics and the second set of characteristics

Example 17. In this example, there is provided a pool automation controller of any or preceding or subsequent examples, wherein the processors are configured to access the memory and execute additional computer-executable instructions to at least prior to receiving the first wireless signal, send, using the shortrange wireless communication device, a third wireless signal to the first wireless communication device, the third wireless signal configured to cause the first wireless communication device to send the first wireless signal.

Example 18. In this example, there is provided a pool automation controller of any or preceding or subsequent examples, wherein the first wireless communication device comprises a first wireless tag and the first and the second wireless communication device comprises a second wireless tag.

Example 19. In this example, there is provided a pool automation controller of any or preceding or subsequent examples, wherein the first wireless tag operates according to a first communication protocol and the second wireless tag operates according to a second communication protocol that is distinct from the first wireless communication protocol.

Example 20. In this example, there is provided a pool automation controller of any or preceding or subsequent examples, wherein the first set of characteristics comprises first time of arrival information for the first wireless signal and the second set of characteristics comprises second time of arrival information for the second wireless signal.

While the present subject matter has been described in detail with respect to specific embodiments thereof, it will be appreciated that those skilled in the art, upon attaining an understanding of the foregoing may readily produce alterations to, variations of, and equivalents to such embodiments. Accordingly, it should be understood that the present disclosure has been presented for purposes of example rather than limitation, and does not preclude inclusion of such modifications, variations, and/or additions to the present subject matter as would be readily apparent to one of ordinary skill in the art. Indeed, the methods and systems described herein may be embodied in a variety of other forms; furthermore, various omissions, substitutions and changes in the form of the methods and systems described herein may be made without departing from the spirit of the present disclosure. The accompanying claims and their equivalents are intended to cover such forms or modifications as would fall within the scope and spirit of the present disclosure.

Unless specifically stated otherwise, it is appreciated that throughout this specification discussions utilizing terms such as “processing,” “computing,” “calculating,” “determining,” and “identifying” or the like refer to actions or processes of a computing device, such as one or more computers or a similar electronic computing device or devices, that manipulate or transform data represented as physical electronic or magnetic quantities within memories, registers, or other information storage devices, transmission devices, or display devices of the computing platform.

The system or systems discussed herein are not limited to any particular hardware architecture or configuration. A computing device can include any suitable arrangement of components that provide a result conditioned on one or more inputs. Suitable computing devices include multipurpose microprocessor-based computing systems accessing stored software that programs or configures the computing system from a general purpose computing apparatus to a specialized computing apparatus implementing one or more embodiments of the present subject matter. Any suitable programming, scripting, or other type of language or combinations of languages may be used to implement the teachings contained herein in software to be used in programming or configuring a computing device.

Embodiments of the methods disclosed herein may be performed in the operation of such computing devices. The order of the blocks presented in the examples above can be varied—for example, blocks can be re-ordered, combined, and/or broken into sub-blocks. Certain blocks or processes can be performed in parallel.

Conditional language used herein, such as, among others, “can,” “could,” “might,” “may,” “e.g.,” and the like, unless specifically stated otherwise, or otherwise understood within the context as used, is generally intended to convey that certain examples include, while other examples do not include, certain features, elements, and/or steps. Thus, such conditional language is not generally intended to imply that features, elements and/or steps are in any way required for one or more examples or that one or more examples necessarily include logic for deciding, with or without author input or prompting, whether these features, elements and/or steps are included or are to be performed in any particular example.

Disjunctive language such as the phrase “at least one of X, Y, or Z,” unless specifically stated otherwise, is otherwise understood within the context as used in general to present that an item, term, etc., may be either X, Y, or Z, or any combination thereof (e.g., X, Y, and/or Z). Thus, such disjunctive language is not generally intended to, and should not, imply that certain examples require at least one of X, at least one of Y, or at least one of Z to each be present.

Use herein of the word “or” is intended to cover inclusive and exclusive OR conditions. In other words, A or B or C includes any or all of the following alternative combinations as appropriate for a particular usage: A alone; B alone; C alone; A and B only; A and C only; B and C only; and all three of A and B and C.

The use of the terms “a” and “an” and “the” and similar referents in the context of describing the disclosed examples (especially in the context of the following claims) are to be construed to cover both the singular and the plural, unless otherwise indicated herein or clearly contradicted by context. The terms “comprising,” “including,” “having,” and the like are synonymous and are used inclusively, in an open-ended fashion, and do not exclude additional elements, features, acts, operations, and so forth. Also, the term “or” is used in its inclusive sense (and not in its exclusive sense) so that when used, for example, to connect a list of elements, the term “or” means one, some, or all of the elements in the list. The use of “adapted to” or “configured to” herein is meant as open and inclusive language that does not foreclose devices adapted to or configured to perform additional tasks or steps. The term “connected” is to be construed as partly or wholly contained within, attached to, or joined together, even if there is something intervening. Recitation of ranges of values herein are merely intended to serve as a shorthand method of referring individually to each separate value falling within the range, unless otherwise indicated herein, and each separate value is incorporated into the specification as if it were individually recited herein. Additionally, the use of “based on” is meant to be open and inclusive, in that a process, step, calculation, or other action “based on” one or more recited conditions or values may, in practice, be based on additional conditions or values beyond those recited. Similarly, the use of “based at least in part on” is meant to be open and inclusive, in that a process, step, calculation, or other action “based at least in part on” one or more recited conditions or values may, in practice, be based on additional conditions or values beyond those recited. Headings, lists, and numbering included herein are for ease of explanation only and are not meant to be limiting.

The various features and processes described above may be used independently of one another, or may be combined in various ways. All possible combinations and sub-combinations are intended to fall within the scope of the present disclosure. In addition, certain method or process blocks may be omitted in some implementations. The methods and processes described herein are also not limited to any particular sequence, and the blocks or states relating thereto can be performed in other sequences that are appropriate. For example, described blocks or states may be performed in an order other than that specifically disclosed, or multiple blocks or states may be combined in a single block or state. The example blocks or states may be performed in serial, in parallel, or in some other manner. Blocks or states may be added to or removed from the disclosed examples. Similarly, the example systems and components described herein may be configured differently than described. For example, elements may be added to, removed from, or rearranged compared to the disclosed examples.

All references, including publications, patent applications, and patents, cited herein are hereby incorporated by reference to the same extent as if each reference were individually and specifically indicated to be incorporated by reference and were set forth in its entirety herein.

These examples are not intended to be mutually exclusive, exhaustive, or restrictive in any way, and the disclosure is not limited to these example embodiments but rather encompasses all possible modifications and variations within the scope of any claims ultimately drafted and issued in connection with the disclosure (and their equivalents). For avoidance of doubt, any combination of features not physically impossible or expressly identified as non-combinable herein may be within the scope of the invention. Finally, references to “pools” and “swimming pools” herein may also refer to spas or other water containing vessels used for recreation, training, or therapy.

What is claimed is:

1. A pool or spa system configured for automated identification of pool or spa equipment, the system comprising:
a plurality of devices of equipment distributed among an area, a first device of equipment of the plurality of devices of equipment comprising a first wireless communication device and a second device of equipment of the plurality of devices of equipment comprising a second wireless communication device; and
pool automation controller comprising:
a shortrange wireless communication device configured to communicate with the first wireless communication device and the second wireless communication device;
a memory configured to store computer-executable instructions; and
one or more processors configured to access the memory and execute the computer-executable instructions to at least:
receive, using the shortrange wireless communication device, a first wireless signal from the first wireless communication device, the first wireless signal comprising a first set of characteristics;
receive, using the shortrange wireless communication device, a second wireless signal from the second wireless communication device, the second wireless signal comprising a second set of characteristics; and
determine locations within the area of the first device and the second device with respect to the pool automation controller based at least in part on the first set of characteristics and the second set of characteristics.

2. The system of claim 1, wherein the first wireless communication device comprises a first wireless tag and the first and the second wireless communication device comprises a second wireless tag.

3. The system of claim 2, wherein the first wireless tag operates according to a first communication protocol and the second wireless tag operates according to a second communication protocol that is distinct from the first wireless communication protocol.

4. The system of claim 1, wherein the first set of characteristics comprises at least one of first time of arrival information for the first wireless signal, first angle of arrival information for the first wireless signal, or first time difference of arrival information for the first wireless signal.

5. The system of claim 1, wherein the first wireless communication device comprises a first shortrange communication device of a same type as the shortrange wireless communication device.

6. The system of claim 1, wherein the shortrange wireless communication device comprises a plurality of antennas, and wherein the first set of characteristics comprises first received signal strength indicator information for the first wireless signal and the second set of characteristics comprises second received signal strength indicator information for the second wireless signal.

7. The system of claim 6, wherein determining the locations of the first device and the second device comprises using triangulation and the first and second set of characteristics.

8. The system of claim 1, wherein a first location of the first device is relative to a second location of the second device.

9. A computer-implemented method for automated identification of pool or spa equipment of a pool or spa system, the method comprising:
detecting a first device of equipment of the pool or spa system based at least in part on a first wireless signal received from a first wireless communication device via a shortrange wireless communication device, the first wireless signal comprising a first set of characteristics;
detecting a second device of equipment of the pool or spa system based at least in part on a second wireless signal received from a second wireless communication device via the shortrange wireless communication device, the second wireless signal comprising a second set of characteristics; and
determine locations of the first device of equipment and the second device of equipment with respect to a different component of the pool or spa system based at least in part on the first set of characteristics and the second set of characteristics.

10. The computer-implemented method of claim 9, further comprising:
identifying a first type of the first device based at least in part on the first set of characteristics;
identifying a second type of the second device based at least in part the second set of characteristics; and
updating a record for the pool or spa system based at least in part on the identified first type and the identified second type.

11. The computer-implemented method of claim 9, further comprising:
generating location information corresponding to the locations of the first device and the second device; and
providing the location information for presentation at a display of the pool automation controller or a user device in network communication with the pool automation controller.

12. The computer-implemented method of claim 9, wherein at least one of the first wireless signal or the second wireless signal comprises a first Wi-Fi signal received via a first Wi-Fi network.

13. The computer-implemented method of claim 9, wherein the locations of the first device of equipment and the second device of equipment are with respect to the pool automation controller communicatively coupled with the shortrange wireless communication device.

14. The computer-implemented method of claim 9, wherein the locations of the first device of equipment and the second device of equipment are unique geographic locations with respect to a pool pad.

15. The computer-implemented method of claim 9, wherein the shortrange wireless communication device is configured to communicate using one or more of a ultra-wideband protocol, a Bluetooth protocol, a near field communication protocol, or an Internet protocol.

16. A pool automation controller for a pool or spa system configured for automated identification of pool or spa equipment, the pool automation controller comprising:
a shortrange wireless communication device configured to communicate with a plurality of wireless communication devices;
a memory configured to store computer-executable instructions; and
one or more processors configured to access the memory and execute the computer-executable instructions to at least:
receive, using the shortrange wireless communication device, a first wireless signal from a first wireless communication device of a first device equipment, the first wireless signal comprising a first set of characteristics;
receive, using the shortrange wireless communication device, a second wireless signal from a second wireless communication device of a second device of equipment, the second wireless signal comprising a second set of characteristics; and
determine locations of the first device of equipment and the second device of equipment with respect to a component of the pool or spa system based at least in part on the first set of characteristics and the second set of characteristics.

17. The pool automation controller of claim 16, wherein the processors are configured to access the memory and execute additional computer-executable instructions to at least prior to receiving the first wireless signal, send, using the shortrange wireless communication device, a third wireless signal to the first wireless communication device, the third wireless signal configured to cause the first wireless communication device to send the first wireless signal.

18. The pool automation controller of claim 16, wherein the first wireless communication device comprises a first wireless tag and the first and the second wireless communication device comprises a second wireless tag.

19. The pool automation controller of claim 18, wherein the first wireless tag operates according to a first communication protocol and the second wireless tag operates according to a second communication protocol that is distinct from the first wireless communication protocol.

20. The pool automation controller of claim 16, wherein the first set of characteristics comprises first time of arrival information for the first wireless signal and the second set of characteristics comprises second time of arrival information for the second wireless signal.
